(19) United States
(12) Patent Application Publication
(10) Pub. No.: US 2020/0392784 A1
(43) Pub. Date: Dec. 17, 2020

(54) DEPLOYABLE STRIP FOR MULTI-SEGMENT RETRACTABLE CURTAIN

(71) Applicants: Andrew C. Lambridis, Dix Hills, NY (US); Ashraf Gomaa, Stony Brook, NY (US); Oscar A. Escobar, Glendale, NY (US)

(72) Inventors: Andrew C. Lambridis, Dix Hills, NY (US); Ashraf Gomaa, Stony Brook, NY (US); Oscar A. Escobar, Glendale, NY (US)

(21) Appl. No.: 16/893,815

(22) Filed: Jun. 5, 2020

Related U.S. Application Data
(60) Provisional application No. 62/860,615, filed on Jun. 12, 2019.

(51) Int. Cl. E06B 9/42; E06B 9/08; A62C 3/02

(52) U.S. Cl. CPC E06B 9/42; E06B 2009/405; A62C 3/0257; E06B 9/08

(57) ABSTRACT

A fastener overlay assembly at an interface between first and second curtain segments of a rolling smoke/fire curtain positioned at an opening in a structure, the curtain segments having leading edges affixed to a bottom bar and extend between opened and closed positions by winding on a barrel assembly, each curtain segment connectable to the other curtain segment by a fastener during unwinding. The overlay assembly has an overlay strip with a leading edge proximate a leading edge of the curtain segment(s); and a retractable overlay collector roller attached to a first end of the overlay strip and configured to allow the overlay strip to unwind from a collector roller synchronously with the winding and unwinding of the curtain segments, wherein the retractable fastener overlay strip is arranged, in its extended position, in front of or behind the fastener that connects the first and second curtain segments.

### CROSS REFERENCE TO RELATED APPLICATIONS

This application claims priority from U.S. Provisional Patent Application Ser. No. 62/860,615 which was filed on Jun. 12, 2019.

### BACKGROUND OF THE INVENTION

### 1. Field of the Invention

The present invention relates to retractable smoke/fire curtains. In particular, the invention pertains to an improved retractable curtain using a strip that is deployable at segment edges of a multi-segment retractable curtain.

### 2. Discussion of Related Art

Existing rolling curtain assemblies may employ multiple adjacent segments of curtain, either due to a large width of an opening required to be covered, or because of a change in curtain segment orientations, such as an opening in a corner of room. It is known to have structure providing an automatic connection between two curtain edges using a zipper or other fastening mechanism, e.g. hook/loop fastener or magnets. Such systems automatically attach opposing curtain segment edges upon deployment of the curtain segments from a retracted state to an extended state, and automatically separate the segment edges when the segments are moved back to their retracted states, namely as they deploy to/from a take-up roller.

In the context of fire or smoke curtains, an extra concern is that when such connections are used to connect adjacent curtain segments, fire and/or smoke, e.g., during a fire condition, can seep through connection seams, such as through the zippered or releasably attached interface of adjacent curtain segments. There is, therefore, a need for an device that inhibits fire and/or smoke leakage at the zippered interface between fire/smoke curtain segments.

### SUMMARY OF THE INVENTION

The terms “fire curtain”, “smoke curtain”; and “fire/smoke curtain” are used interchangeably to reference a curtain having fire and/or smoke blocking capabilities.

In accordance with a first aspect of the invention, a fastener overlay assembly is arranged at an interface between a first curtain segment and a second curtain segment of a retractable curtain, positioned at an opening in a structure. The curtain segments are comprised from smoke and/or fire retardant material. The curtain segments have leading edges affixed to a bottom bar and configured to extend between opened and closed positions by winding on and unwinding from a barrel assembly. Each curtain segment is connectable to the other curtain segment adjacent thereto by a fastener at respective adjacent edges of each curtain segment during unwinding. The overlay assembly has an overlay strip having a leading edge proximate a leading edge of at least one of the first and second curtain segments; and a retractable overlay collector roller attached to a first end of the overlay strip and configured to allow the overlay strip to wind on and unwind from a collector roller synchronously with the winding and unwinding of the first and second curtain segments with respect to the barrel assembly. The retractable fastener overlay strip is arranged, in its extended position, in front of or behind the fastener that connects the first and second curtain segments.

In one embodiment, the leading edge of the overlay strip is also attached to the bottom bar so that movement of the bottom bar extends the overlay strip from the collector roller.

In another embodiment, the barrel assembly comprises a first barrel assembly for deploying the first curtain segment and a second barrel assembly for deploying the second curtain segment.

In still another embodiment, a designated barrel assembly is provided for each curtain segment, and the barrel assemblies are deployed synchronously with each other.

In still a further embodiment, the fastener overlay assembly has a holder mounted to the structure and to which the retractable overlay roller is rotatably mounted to rotate with respect to the holder.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The figures are described as follows:

FIG. 1 is an isometric view of a retractable overlay assembly that deploys a strip that functions as a fastener overlay arranged at an interface between two curtains;

FIG. 2 is a magnified view of an area A of FIG. 1;

FIG. 3 is a schematic isometric view of the retractable overlay assembly with the strip that functions as a fastener overlay being illustrated to show the fastener behind the strip;

FIG. 4 is a schematic rear elevation view of the retractable overlay assembly deployed at the interface between two curtains, showing the automatic fastener;

FIG. 5 is a plan view of the retractable overlay assembly deployed at the interface between two curtains; and

FIG. 6 is a rear view of the retractable overlay assembly, showing the automatic fastener.

### DETAILED DESCRIPTION OF THE PRESENTLY PREFERRED EMBODIMENTS

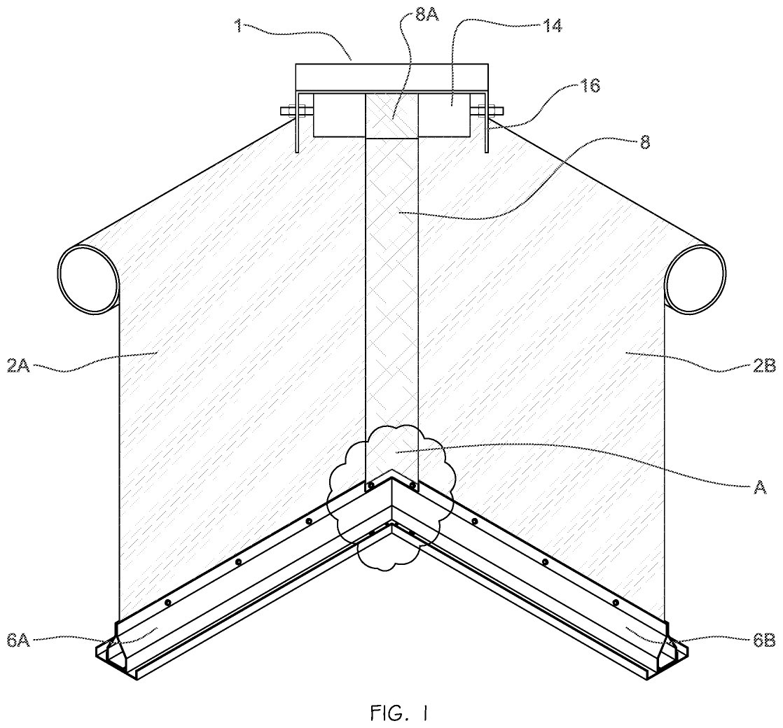

FIGS. 1-6 show various views of a retractable fastener overlay assembly 1 that is arranged at an interface between a first curtain segment 2A and a second curtain segment 2B and that includes a retractable fastener overlay strip 8 of material arranged, in its extended position, in front of a fastener 10 that connects adjacent edges of the first and second curtain segments 2A and 2B. The curtain segments are made of fire retardant material and/or smoke blocking material, or of textile fabric coated with a fire and/or smoke retardant or smoke blocking material, as is known by those of ordinary skill in the art.

The exemplary illustrated interface is used at a corner interface of two curtain segments. However, the retractable fastener overlay assembly 1 is not limited to use at a corner interface. The retractable fastener overlay assembly 1 can also be utilized at an interface that is flat (180 degrees), or at any interface between curtain segments, whatever the interface angle.

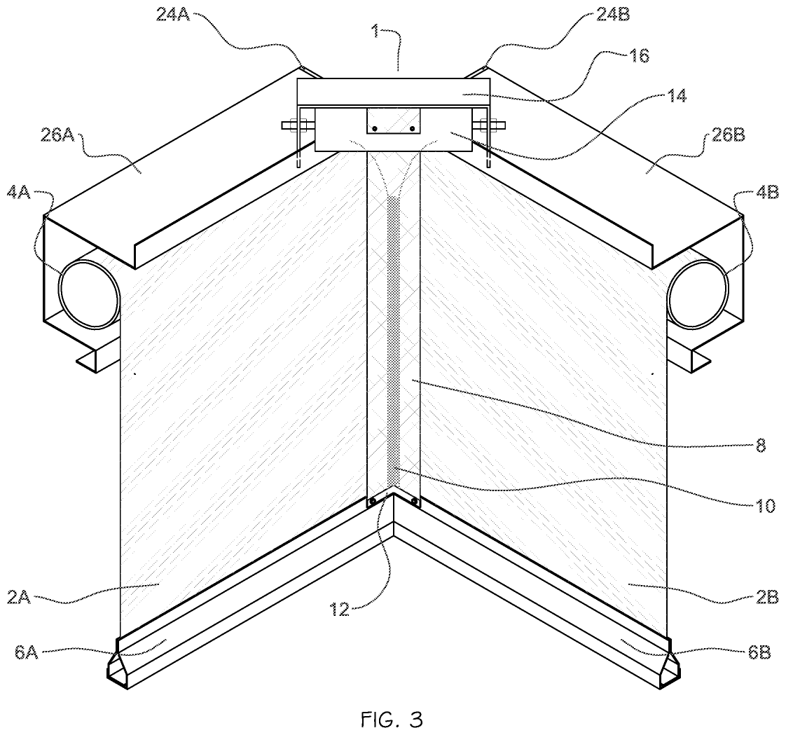

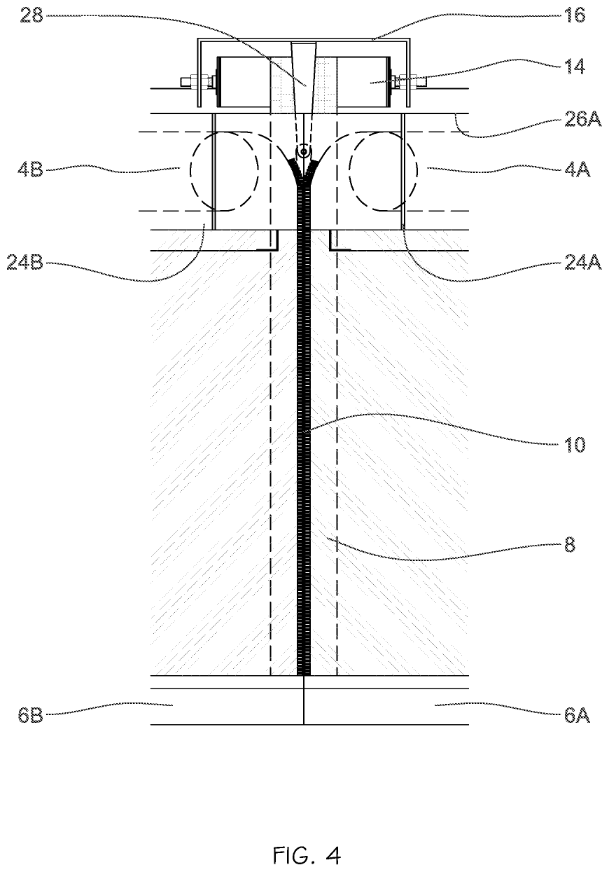

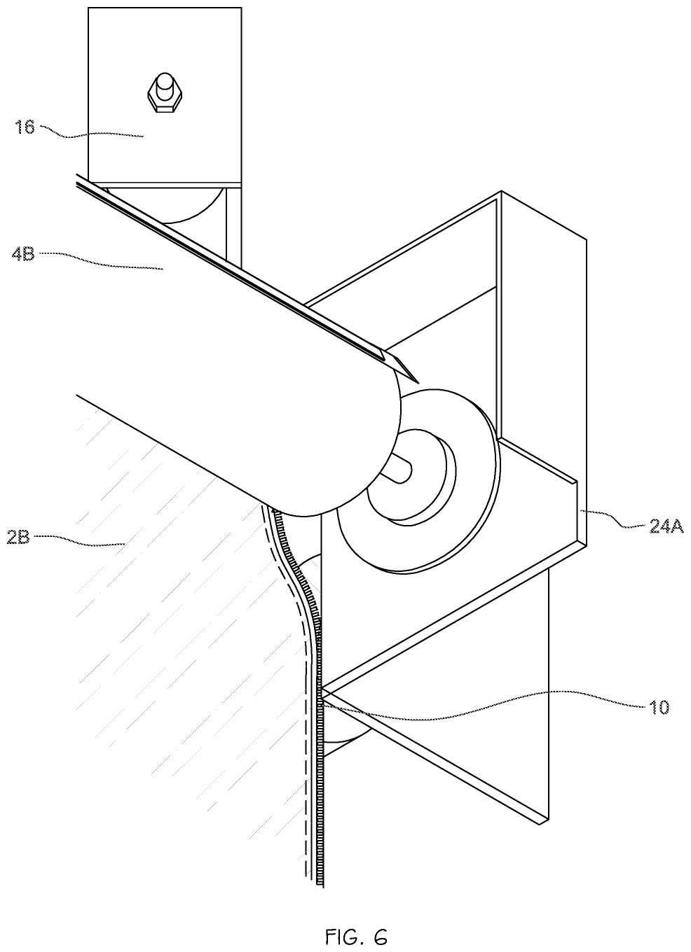

As can be seen in the views of FIGS. 3-5, curtain segment 2A is windable onto a barrel assembly 4A, and curtain segment 2B is windable onto a barrel assembly 4B. So as to maintain the orientation between the first and second curtain segments, the two barrel assemblies 4A and 4B are configured and arranged so as to wind and unwind in a synchronous manner, for example, by placement of a synchronous gearing connection between them, or universal joint for non-90° corners, which would allow a single motor (not shown) to operate both barrels, or by two synchronized motors. Curtain segments 2A and 2B each have a leading edge fastened to a respective bottom bar 6A, 6B, such as by rivets, screws, or any other suitable manner, whereby, in an extended state, the bottom bars 6A and 6B are positioned on a floor about an opening, as shown in FIG. 1. Also as shown in the illustrated embodiment, the bottom bars are connected to each other at a corner. The curtain segments are connected to one another along their respective lengths by the fastener 10, for example a zipper, visible in rear views FIGS. 4 and 6, and also visible as a see-through view portion of FIG. 3 to connect adjacent edges of the curtain segments together.

To securely connect the edges of the two curtain segments 2A, 2B, each of which is windable onto respective barrel assemblies 4A, 4B, the edges at which the curtain segments meet one another are connected by the fastener 10 when the overall curtain is in an extended position. For example, the fastener 10 can be an automatic zipper system that forms a connected zippered seam between edges of the adjacent curtain segments. The automatic zipper system is configured to zip the adjacent edges of the curtain segments together when the two curtain segments are extended, that is, unwound from their respective barrels, to the extended position, namely, as the curtain segments are deployed with respect to an opening. When the curtain segments are retracted or wound back onto their respective barrels, the zippered seam is gradually opened, allowing each of the curtain segments to be completely wound onto its respective barrel assembly.

Other fastening interfaces can, likewise, be deployed by those of ordinary skill in the art such as, for example, hook and loop fasteners where adjacent edges of curtain sections will have a strip of hooks or loops, respectively, or a strip of metal on one interface and a strip of magnetic material on an opposing interface, to provide for attachment and detachment of the curtain segments during deployment/retraction.

The fastener location, i.e. the zipper seam, magnet/metal or hook and loop fastener seam, may be prone to seepage wherein smoke from one side of the attached curtain segments will pass through the seam to the other side of the curtain segments. This can result in an unsatisfactory safety condition. To alleviate this concern, an embodiment of the present invention provides a retractable fastener overlay assembly 1 arranged at the interface between the first curtain segment 2A and the second curtain segment 2B. The retractable fastener overlay assembly 1 includes a retractable overlay strip 8 arranged, in its extended position, in front of or behind the fastener 10 that connects the first and second curtain segments 2A and 2B. This is achieved by the fastener overlay strip 8 being itself windable onto a retractable overlay collector barrel 14 positioned proximate the fastener 10 (see FIG. 3) and having a leading edge affixed to one or both of the bottom bars 6A, 6B. Thus, as the bottom bars are extended toward the floor of the opening, the overlay strip 8 will be deployed from barrel 14.

The retractable overlay collector barrel 14 is configured to provide an urging force, such as a spring bias, in a direction to urge the overlay strip 8 toward barrel 14. Such a configuration allows the overlay strip 8 to remain taut closely follow the curtain segments 2A and 2B up and down in a synchronized manner, without the need for a separate motor for the retractable overlay collector barrel 14.

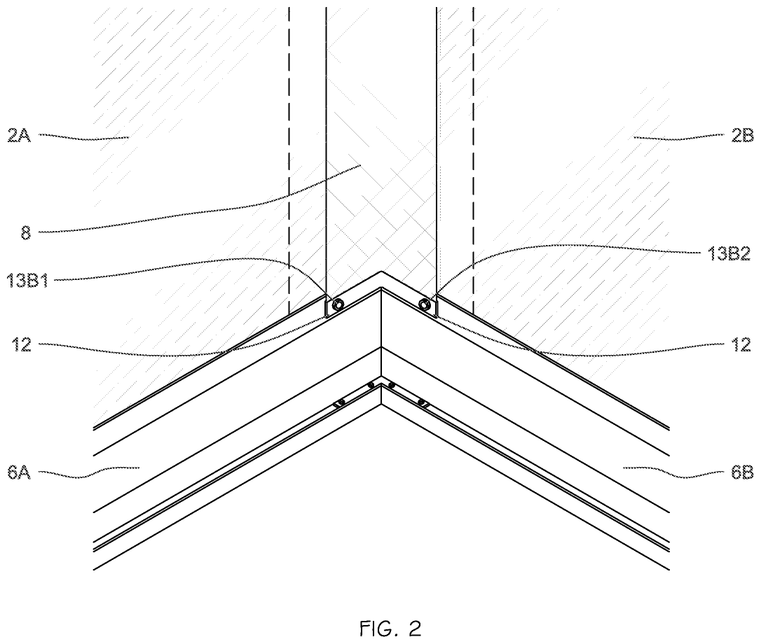

More particularly, the bottom bar assemblies 6A and 6B are affixed to the leading edges of curtain segments 2A and 2B, respectively, and to the bottom of the overlay strip 8. In this manner, even upon a synchronous winding up (i.e., retraction) of the two curtain segments 2A and 2B, the bottom bar assemblies allow the two curtain segments and the overlay strip 8 to maintain their relative positions with respect to one another. As can be seen in FIG. 2, which is a magnified view of area A in FIG. 1, an angled overlay bottom bar connector 12 is attached to the curtain segment bottoms, and to the bottom corners of the overlay strip 8, using bolts 13B1 and 13B2. The angle of the bottom bar connector is configured to match the interface angle between the curtain segments 2A and 2B.

With reference to FIG. 3, each barrel assembly 4A, 4B is arranged within a respective hood 26A, 26B. Also, the retractable overlay collector (barrel) 14 is arranged within a collector mounting holder 16, and engages side portions of the holder 16, to allow rotation of the overlay collector (barrel) 14 during deployment and retraction of the overlay strip 8.

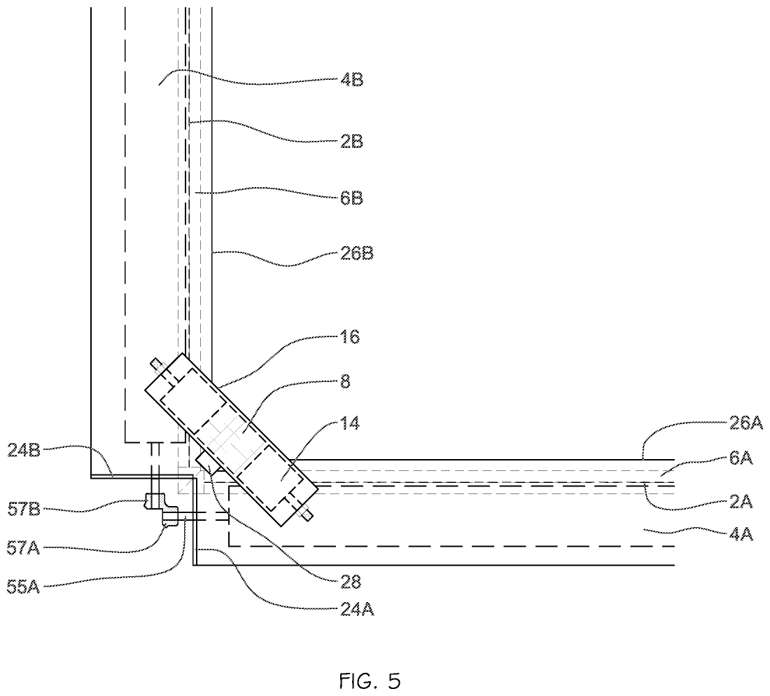

In the illustrated embodiment, for example as seen in FIGS. 4 and 5, the collector mounting holder 16 is affixed to the point at which hoods 26A and 26B meet one another and overlaps portions of both hoods. An automatic fastener holder 28 extends from the top of the collector mounting holder 16 downward vertically to a connection point that is coaxial with the axis of the automatic fastener 10.

Support brackets 24A and 24B are provided to support the barrel assemblies. FIG. 6, for example, shows the support bracket 24A connected to a structure of the building opening across which the assembly is mounted to support the weight of the fire curtain assembly.

As can be seen in FIG. 5, each barrel assembly 4A, 4B has, at one end, a respective barrel shaft 55A, 55B. Each barrel shaft is configured to wind and unwind in a synchronous manner through the use of separate motor operators for each barrel, or by connecting the barrels to each other through gearing or the like such that a single operator motor can be used.

The upward urging force on the overlay strip 8, combined with the fact that the strip 8 is connected fixedly to the bottom bar assemblies 6A and 6B prevent slack from forming between the curtain segments 2A, 2B and the overly strip 8 when the curtain is deployed. Further, the pressure differential between the volume of air in front of the curtain and the air behind the curtain, particularly during a fire condition, maintains a slight bowing frontwardly of each curtain segment, which also provides a force that helps to maintain the contact between the edges of the overlay strip 8 and the curtain segments 2A, 2B.

In practice, the overlay strip 8 snugly positions against the interface of the curtain segments to provide an additional barrier to fire and/or smoke that may be present behind or in front of the fire curtain in the event of a fire or smoke condition.

While the invention has been shown, for purposes of illustration, with respect to disclosed exemplary embodiments, the invention is not limited to the disclosed embodiments. For example, although two curtain panels or segments are depicted, additional panels can be likewise employed with additional overlay strips 8 and related assemblies at each interface of adjacent curtain segments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A fastener overlay assembly arranged at an interface between a first curtain segment and a second curtain segment of a retractable curtain, positioned at an opening in a structure, the curtain segments having leading edges affixed to a bottom bar and configured to extend between opened and closed positions by winding on and unwinding from a barrel assembly, each curtain segment being connectable to the other curtain segment adjacent thereto by a fastener at respective adjacent edges of each curtain segment during unwinding, the overlay assembly comprising:
an overlay strip having a leading edge proximate a leading edge of at least one of the first and second curtain segments; and
a retractable overlay collector roller attached to a first end of the overlay strip and configured to allow the overlay strip to wind on and unwind from a collector roller synchronously with the winding and unwinding of the first and second curtain segments with respect to the barrel assembly,
wherein the retractable fastener overlay strip is arranged, in its extended position, in front of or behind the fastener that connects the first and second curtain segments.

2. The fastener overlay assembly of claim 1, wherein the leading edge of the overlay strip is attached to the bottom bar.

3. The fastener overlay assembly of claim 1 wherein the overlay strip has a width that is wider than a width of the fastener.

4. The fastener overlay assembly of claim 1, wherein the barrel assembly comprises a first barrel assembly for deploying the first curtain segment and a second barrel assembly for deploying the second curtain segment.

5. The fastener overlay assembly of claim 4, wherein the first and second barrel assemblies are deployed synchronously with each other.

6. The fastener overlay assembly of claim 1, further comprising a holder mounted to the structure and to which the retractable overlay roller is rotatably mounted to rotate with respect to the holder.

7. The fastener overlay assembly of claim 6, wherein the holder is positioned in alignment with the fastener.

8. The fastener overlay assembly of claim 1, wherein the overlay strip is comprised of smoke retardant material.
